(19) United States
(12) Patent Application Publication
(10) Pub. No.: US 2005/0198169 A1
(43) Pub. Date: Sep. 8, 2005

(54) Storage process and system for electronic messages

(75) Inventors: John Holten, South Yarra (AU); Tim Barnett, South Yarra (AU); Grant Gray, Fairfield (AU); Ian Millsom, Frankston (AU)

Correspondence Address: INSKEEP INTELLECTUAL PROPERTY GROUP, INC, 1225 W. 190TH STREET, SUITE 205, GARDENA, CA, 90248, US

(73) Assignee: Arc-e-Mail Ltd.

(21) Appl. No.: 11/005,551

(22) Filed: Dec. 6, 2004

(30) Foreign Application Priority Data
Jun. 6, 2002 (AU) PS2818
Jun. 6, 2003 (WO) PCT/AU03/00715

(51) Int. Cl. G06F 15/16

(52) U.S. Cl. 709/206

(57) ABSTRACT

A storage process for electronic messages, the process including the steps of receiving an electronic message over a messages network, generating metadata for the message that verifies content of the message, and archiving the message and the metadata to verify sending and content of the message. The invention also relates to a system for storing electronic messages. The process and system are particularly useful in situations where it is necessary to verify the contents of an electronic message to ensure that it is not altered. One advantage of the invention is that it provides a secure tamper-proof record of electronic messages that is kept secure and cannot be readily destroyed.

### CROSS REFERENCE TO RELATED APPLICATIONS

This invention is related to and claims priority from Australian Patent Application No. PS 2818, filed Jun. 6, 2002, entitled A Storage Process And System; and PCT Application No. PCT/AU03/00715, filed Jun. 6, 2003, entitled A Storage Process And System For Electronic Messages, which are incorporated herein by reference.

### FIELD OF THE INVENTION

The present invention relates to a storage process and system for archiving electronic messages.

### BACKGROUND

Most businesses are dependent upon some form of electronic communication. For example, electronic mail or ‘email’ is often the dominant form of communication within a business, and a major form of communication with external customers and other businesses. In many countries, electronic communications are subject to special legal requirements. For example, legislation may require businesses to archive most electronic communications. Moreover, privacy legislation may require businesses to ensure that their employees' rights to privacy are protected from intrusion by unauthorized third parties, and internally administered networks may not always provide the required level of security. It is also generally considered prudent to maintain secure off-site data backups of company information. However, many businesses are concerned about the security of electronic communications over insecure networks. In particular, it may be important to provide secure archiving or storage of electronic communications or other documents in a manner that is not open to influence, tampering or abuse either internally or externally, for satisfying evidentiary rules in court proceedings, for example.

It is desired, therefore, to provide a storage process and system that alleviate one or more difficulties of the prior art, or at least provide a useful alternative to existing storage processes and systems.

### SUMMARY OF THE INVENTION

In a first aspect, the present invention provides a storage process for electronic messages, the process including the steps of:

receiving an electronic message over a messages network;

generating metadata for the message that verifies content of the message; and

archiving the message and the metadata to verify sending and content of the message.

The present invention is particularly useful in situations where it is necessary to verify the contents of an electronic message to ensure that it is not altered. The present invention is also advantageous in that it may provide a secure record of electronic messages that is kept secure and cannot be readily destroyed.

Preferably, the process includes providing read-only access to the archived message. This further safeguards the information provides additional security.

The term metadata refers to any suitable data that verifies the content of the message, it may be generated in any suitable manner. In one form of the invention, the metadata is generated by processing the message according to an encryption algorithm.

Preferably, the metadata is stored together with the message embedded within the archived message. The metadata may be in any suitable form, in one particularly preferred form it is a digital fingerprint which verifies sending and content of the message. In one form, the metadata includes a checksum of the message, provision of a checksum assists in providing verification that the content of the message has not been altered. Preferably, the metadata includes a timestamp of the message indicating when the message was sent.

In one form, the process includes determining whether a sender of the message is allowed access to the steps of the process on the basis of at least one of an email address of the sender and/or a network address associated with the sender. This may, for example, occur where the sender is a subscriber to a system embodying the present invention.

In another form of the process, the message is addressed to at least one recipient, and the process includes the step of determining whether the recipient is a local recipient or a non-local recipient. The process may additionally or alternatively include determining whether a sender of the message is allowed access to relay the electronic message for a non-local recipient of the electronic message on the basis of a network address associated with the sender.

Additionally or alternatively, the process includes storing the message for subsequent downloading to a remote computer system by a local recipient. The process may also include denying access to the step of downloading on the basis of at least one of a network address of the remote computer system, the status of an account of the recipient, time of day, and day of week.

The process may include the step of determining whether the message can be forwarded to a non-local recipient on the basis of access privileges of the sender.

In one preferred form of the invention, the process includes determining whether the message includes a computer virus. In the event that a computer virus is detected then the invention may notify the sender and/or recipient if the message includes a computer virus.

In another preferred form of the invention, the invention includes the process includes determining whether the message includes SPAM. Preferably, the archiving step does not occur if the message includes SPAM. The process may also include the step of notifying the sender and/or recipient that SPAM has been sent.

The process may include selecting the message on the basis of one or more attributes of the message. Such attributes may include one or more of size, time received, time sent, and recipient of the message.

The process may also additionally or alternatively include determining whether the message includes a word and/or phrase from a list of predetermined words and/or phrases. This allows for the filtering of messages where necessary.

A privacy statement may be appended to the message; the privacy statement may then be forwarded to the recipient.

The step of receiving includes receiving the message using a simple mail transfer protocol (SMTP). Preferably, the electronic message includes an email message. The email message may or may not include an attached document.

The present invention may optionally allow access to the steps of the process in exchange for a fee.

The archived messages may be indexed or sorted in any suitable manner. Preferably, the process includes generating one or more index terms for the message, and the step of archiving includes archiving the index terms. This increases the efficiency of retrieving messages from storage. The index terms may be generated in any suitable manner. In one form, the index terms are generated from header data and/or body text of the message. Preferably, each of the index terms includes at least one word.

Where a user of the process wishes to store data then they may utilize the present invention by sending an electronic mail to a pre-determined address associated with the storage means. It is not necessary that the electronic message is delivered to the recipient, the user may designate that the message is to be stored and not forwarded to an addressed recipient. This may occur, for example, by addressing the message to a storage means that conducts the steps of the process.

The message is preferably received by intercepting the message on route to the recipient to whom the message is addressed, and the steps of the process are then conducted on the intercepted message. Preferably, the message is automatically forwarded to the recipient to whom the message is addressed after interception. The message may be selectively forwarded to the recipient to whom the message is addressed on the basis of one or more criteria. The criteria may include one or more of:

(a) whether the message is identified as SPAM;

(b) whether the message contains as computer virus;

(c) whether the message contains one or more predetermined words and/or phrases;

(d) whether a sender of the message is on a blacklist associated with a recipient of the message; and

(e) whether a recipient of the message is on a blacklist associated with the sender of the message.

The archived message may be stored at a storage means located on a secure computer remote from a sender and a recipient to whom the message is addressed.

In a second aspect of the present invention, there is provided a storage process for electronic messages sent between a sender and a recipient via a messages network, including the steps of:

intercepting the electronic message on route to the recipient;

creating an archive copy of the intercepted message;

generating metadata to verify content of the archive copy; and

archiving the archive copy and the meta data to verify sending and content of the electronic message.

In a third aspect of the present invention, there is provided a system for storing electronic messages, the system including:

receiving means for receiving an electronic message over a messages network;

encryption means for generating metadata for the message that verifies content of the message; and

storage means for archiving the message and the metadata to verify sending and content of the message.

Preferably, the storage means provides only read-only access to the message.

The encryption means may optionally include an encryption algorithm and the message is processed according to the encryption algorithm to generate the metadata.

In one form of the invention, the system includes embedding means for embedding the metadata into the archived message. Preferably, the metadata is a digital fingerprint verifying sending and content of the message.

Additionally or alternatively, the system includes virus detection means for detecting a computer virus within the message.

The system of the present invention may include an unsolicited message detection means for detecting SPAM within the message.

The receiving means may optionally include interception means for intercepting electronic messages on route to a recipient to whom the message is addressed.

In a particularly preferred form of the invention, the system includes means for detecting whether the recipient to whom the message is addressed is a local or non-local recipient.

Preferably, the metadata includes a checksum of the message. Additionally or alternatively, the metadata includes a timestamp of the message indicating when the message was sent.

In a fourth aspect of the invention, there is provided a storage process for electronic messages sent and received by a user, the process including the steps of:

intercepting electronic messages sent and received by the user;

analysing each electronic message according to pre-determined criteria; and

creating an archive copy of each electronic message which meets the pre-determined criteria; and for each archive copy, including the further steps of:

(i) generating a validation data for the archive copy to verify its content; and

(ii) archiving the archive copy and the validation data to verify sending and content of the electronic message.

Preferably, the user is a subscriber.

In a fifth aspect of the invention, there is provided an electronic message management system, the system including:

tracking means for tracking electronic messages sent to and from a subscriber; and

storage means for storing electronic messages sent to and from a subscriber wherein the electronic messages are stored in a tamper proof manner to provide proof of content and sending.

In a sixth aspect of the invention, there is provided computer software including:

tracking component to track electronic messages sent and received by the user;

encryption component to generate metadata for one or the electronic messages to verify content of the message; and

storage means for storing the message and metadata in a secure manner to verify sending and content of the message.

In a seventh aspect, the present invention also provides a storage process for electronic messages, including:

receiving an electronic message over a messages network;

generating one or more index terms for the message; and

storing the message and the index terms.

Preferably, the process includes generating metadata for the message that verifies content of the message, and the step of storing includes storing the metadata. The index terms may be generated from header data and/or body text of the message. Preferably, each of the index terms includes at least one word.

The present invention also provides a process for determining one or more electronic messages, including:

receiving, over a communications network, a request for one or more archived electronic messages, the request including one or more index terms; and

querying at least one database for electronic messages matching the request on the basis of the index terms, the at least one database including a plurality of entries for respective index terms, each of the entries identifying an index term and one or more corresponding messages.

Preferably, the index terms correspond to header data and/or body text of the corresponding messages. Each of the index terms may include at least one word.

The present invention also provides a system having components for executing the steps of any one of the above processes. The present invention also provides software having program code for executing the steps of any one of the above processes. The present invention also provides a computer readable storage medium having stored thereon program code for executing the steps of any one of the above processes.

The present invention also provides a storage system, including one or more storage servers for receiving an electronic message over a messages network, and for generating metadata for the message to verify content of the message, and at least one database server for storing the message with the metadata to verify sending and content of the message.

Preferably, the storage system includes a web server for providing access to stored messages over a messages network.

Preferably, the system includes means for receiving the message, selecting one of the storage servers on the basis of load information received from at least one of the storage servers, and forwarding the message to the selected storage server.

It is to be understood that the optional features described in relation to the first aspect of the invention are also equally applicable to each of the other aspects described.

### BRIEF DESCRIPTION OF THE DRAWINGS

Preferred embodiments of the present invention are hereinafter described, by way of example only, with reference to the accompanying drawings, wherein:

FIG. 1 is schematic diagram of a preferred embodiment of a storage system connected to remote private networks via a public communications network;

FIG. 2 is a block diagram of a storage server of the storage system;

FIG. 3 is a block diagram of a router of the storage system;

FIG. 4 is a block diagram of a client computer system of a private network;

FIG. 5 is a block diagram of a mail server of the private network;

FIGS. 6 and 7 are flow diagrams of a storage process executed by the storage server; and

FIG. 8 is a flow diagram of an analysis process of the storage process.

### DETAILED DESCRIPTION OF THE PREFERRED EMBODIMENTS

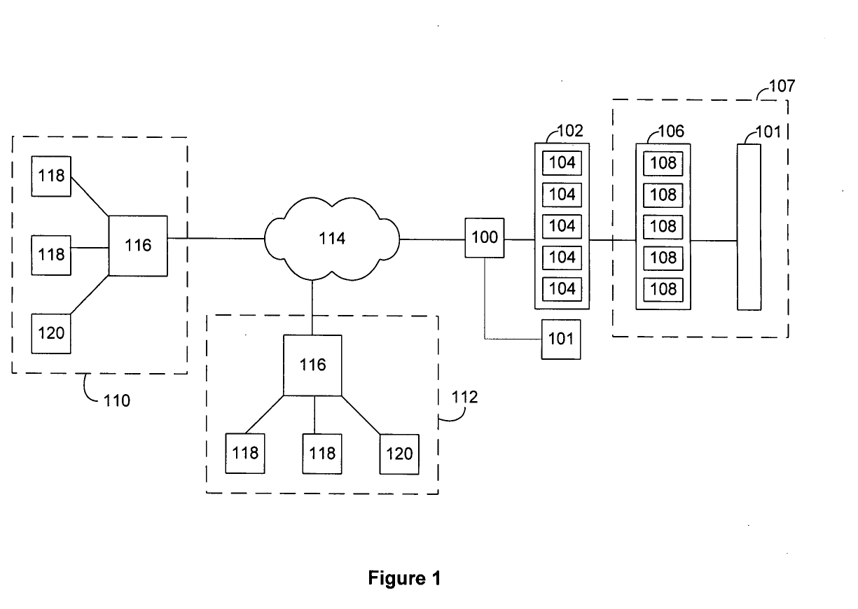

As shown in FIG. 1, a storage system includes a router 100, a domain name system (DNS) server 101, a farm 102 of storage servers 104, and a database 107 comprising a farm 106 of database servers 108 connected to non-volatile storage media 101. The database servers 108 are standard high-performance file servers and the non-volatile storage media 101 includes a redundant array of independent disks (RAID). The storage system communicates with first 110 and second 112 remote private networks via a public communications network 114, such as the Internet. Each of the private networks 110, 112, includes a router 116, client computer systems 118, and a mail server 120.

The storage system executes a storage process that provides secure remote storage of email communications and other documents via the Internet 114 for domains electing to use the services of the storage system, referred to herein as hosted domains, such as the first private network 110. In the described embodiment, the storage process is implemented as software modules executed by the storage servers 104, which are standard computer systems, such as Intel™-based personal computer systems running a Linux™ operating system. However, it will be apparent that at least part of the storage process may be implemented by dedicated hardware components such as application-specific integrated circuits (ASICs).

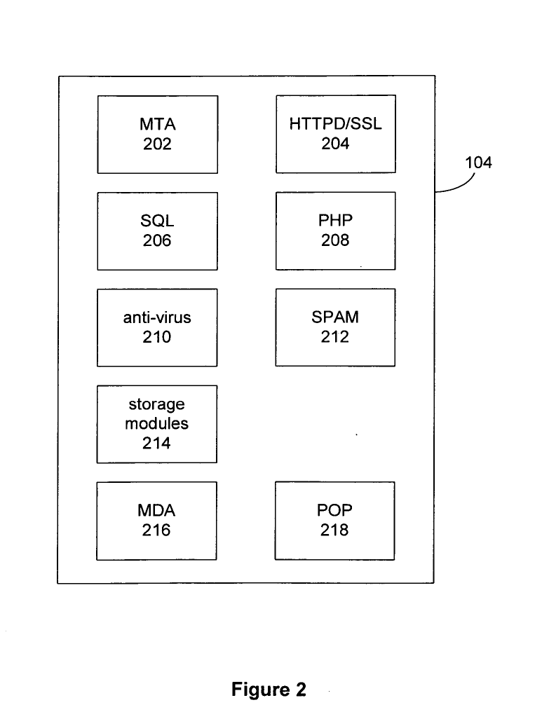

As shown in FIG. 2, each storage server 104 includes:

(i) a mail transfer agent (MTA) module 202 that includes code for the storage process;

(ii) a web server module 204 such as Apache, available from www.apache.org;

(iii) a structured query language (SQL) server module 206 such as MySQL, available from http://www.mysql.com/;

(iv) an SQL-HTML interface module 208, such as PHP, available from www.php.net,

(v) a virus scanning module 210 such as ScanMail™, available from http://www.antivirus.com;

(vi) a spam filtering module 212 such as Vipul's Razor, available from HTTP://razor.sourceforge.net, the mail abuse prevention system (MAPS), available from HTTP://mail-abuse.org/rbl, or the real-time black hole list (RBL);

(vii) a mail delivery agent (MDA) 216;

(viii) a post-office protocol (POP) server 218; and

(ix) storage modules 214.

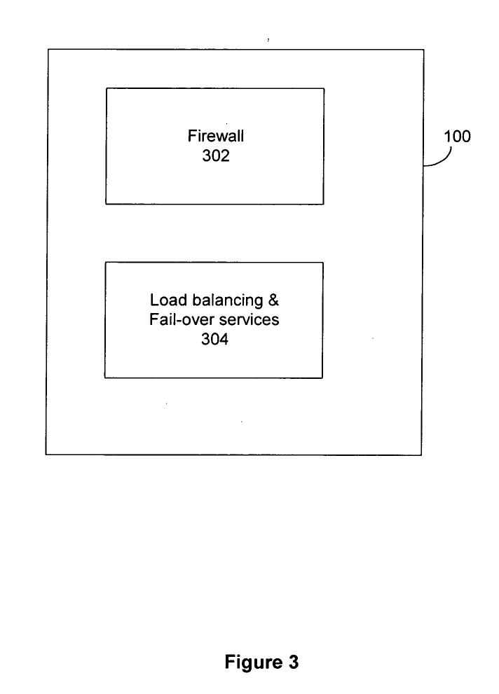

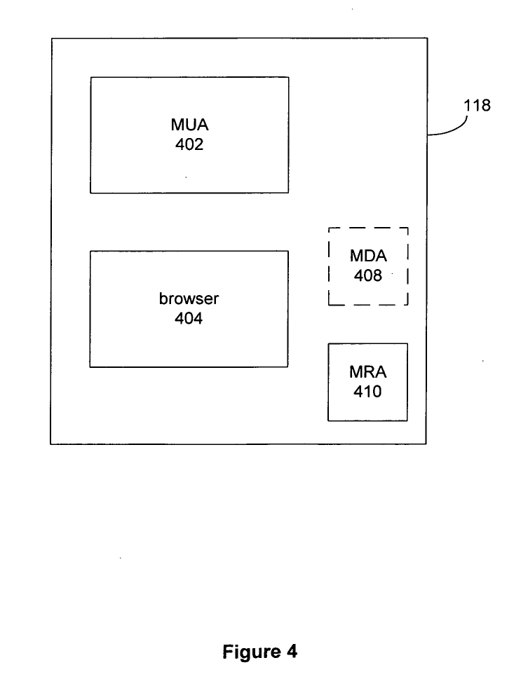

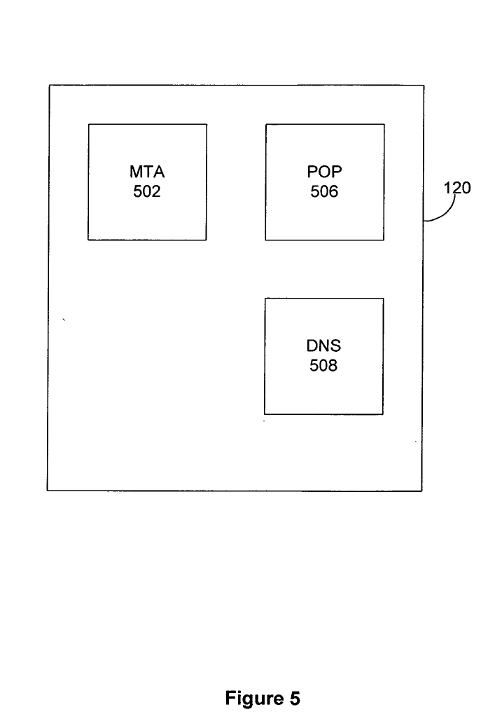

As shown in FIG. 3, the router 100 of the storage system includes a firewall module 302, and a load balancing and failover services module 304 such as Piranha, available from HTTP://freshmeat.net/projects/piranha. As shown in FIG. 4, each client computer system 118 includes a standard web browser 404 supporting secure sockets layer (SSL) encryption, such as Microsoft Internet Explorer™ or Netscape Navigator™. The client computer system 118 also includes a mail user agent (MUA) 402 and a mail retrieval agent (MRA) 410. The MUA 402 is used for composing and reading email messages, and for sending email messages to the mail server 120 on its local network using the simple mail transfer protocol (SMTP). The MRA 410 is used for retrieving email messages from remote servers using a suitable protocol such as the post office protocol, version 3 (POP3) or the Internet message access protocol (IMAP). In the described embodiment, the MUA 402 is an integrated email application, such as Microsoft Outlook™ or Netscape Messenger™, incorporating the MRA 410. However, it will be appreciated by those skilled in the art that, particularly if the client computer system 118 runs a Unix™ operating system, the MUA 402 can be a simpler email application such as an MH application, Elm, Mush, or Pine, and the MRA 410 can be a separate application such as fetchmail. Such a system would also typically include a mail delivery agent (MDA) 408 such as procmail for delivering email messages to users of the client computer system 118. As shown in FIG. 5, the mail servers 120 of the private networks 110, 112, include an MTA 502, a mail delivery agent (MDA) 504 such as procmail or Microsoft Exchange™, a POP server 506, and a domain name server (DNS) 508.

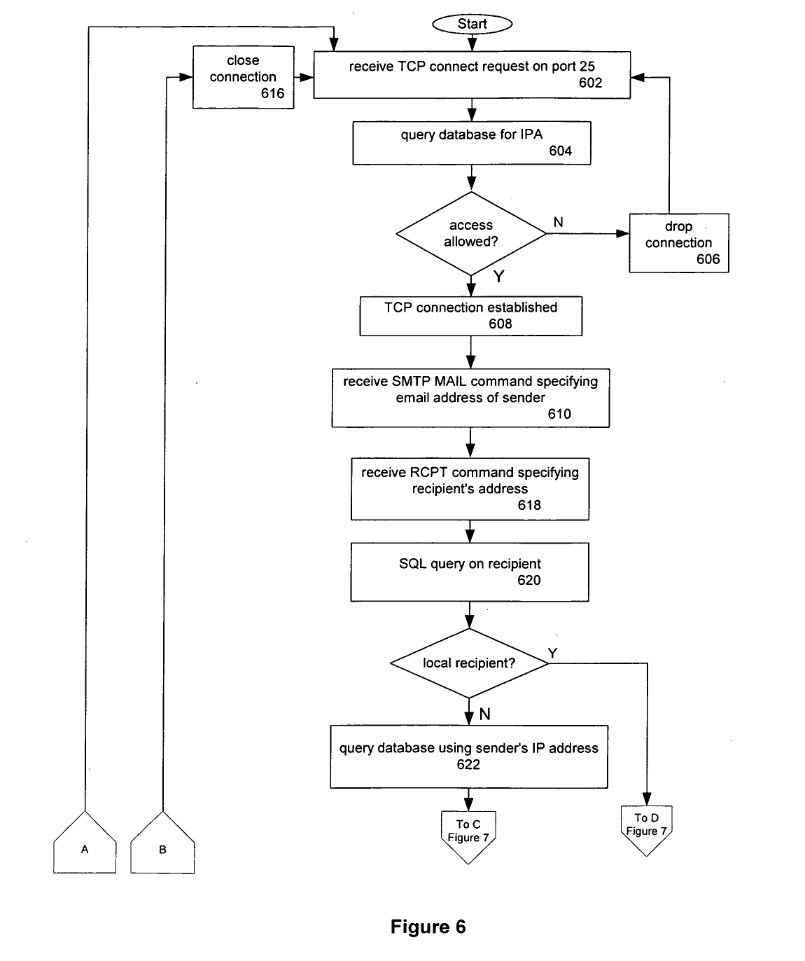

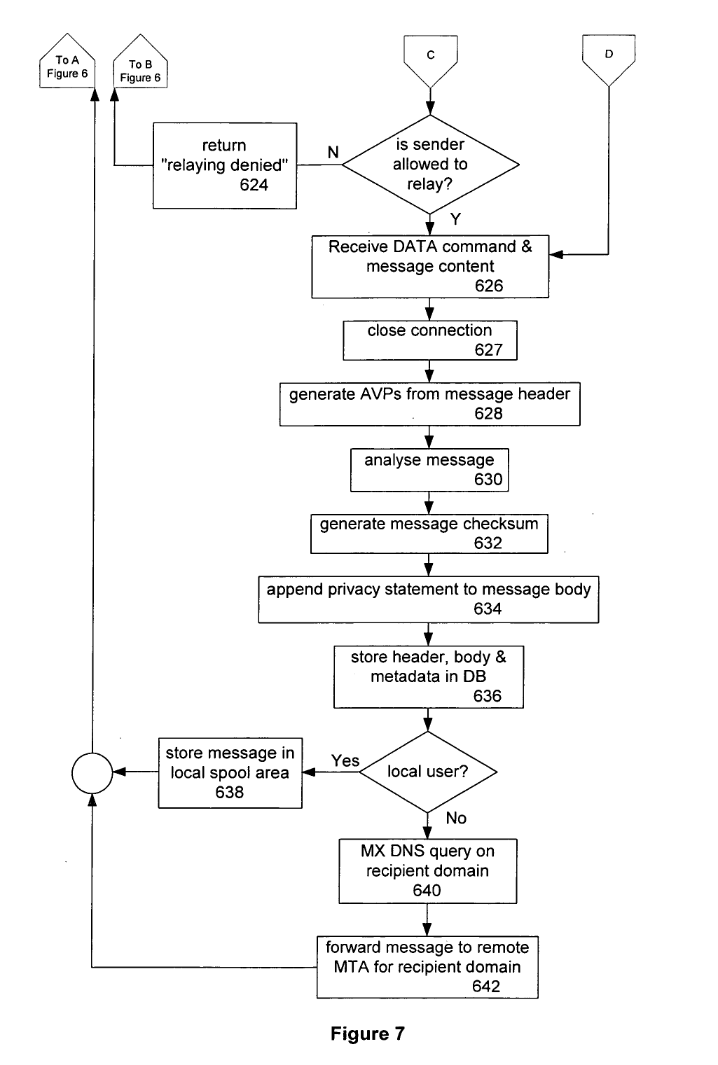

The storage system executes a storage process, as shown in FIGS. 6 and 7, that provides secure archiving of incoming and outgoing email messages and other documents for users of hosted domains such as the first private network 110. The second private network 112 is not hosted by the storage system. To enable use of the storage system for incoming email to the first private network 110, the DNS records for the domain of the first private network 110 are modified to specify an IP address of the DNS server 101 of the storage system as the authoritative address for mail exchange (MX) records for that domain. To enable use of the storage system for outgoing email, the configuration of the MUA 402 is modified for each user of the first private network 110 to specify the farm 102 of storage servers 104 as the SMTP server for outgoing mail.

For example, using the MUA 402 of one of the client computer systems 118, a user of the first private network 110 can compose an email message addressed to a user of the second private network 112 and attach an electronic document to the message. When the message is ready for sending, the user, hereinafter referred to as the sender, clicks a button labelled “send” in a graphical user interface (GUI) generated by the MUA 402 in order to send the message to the recipient. Because the MUA 402 is configured to use the farm 102 of storage servers 104 as the SMTP server for outgoing mail, the MUA 402 initiates a transport control protocol (TCP) connection to that IP address.

The storage process begins at step 602 when this TCP connection request (i.e., a TCP packet with the SYN flag set to 1) directed to port 25 of the storage server from 102 is received by the router 100. The firewall module 302 of the router 100 performs standard level 4 packet filtering to reject packets with disallowed source IP addresses and/or port numbers. If the packet is allowed, the load balancing module 304 selects one of the storage servers 104 from the server farm 102, based on load and availability information provided by the storage servers 104. Once a storage server has been selected, the packet is forwarded from the router 100 to that server.

The request packet is received on port 25 of the selected server by the MTA module 202, which then queries the database 107 to determine whether the source IP address of the packet is allowed access to the storage system. If the IP address is not allowed, then at step 606, the connection is dropped, and the storage process returns to wait for another connection at step 602. Otherwise, a TCP connection is established between the selected storage server 104 and the sender's computer 118 at step 608. The MTA 202 sends an SMTP ready message to the MUA 402 to initiate the sending of the email message from the MUA 402 to the MTA 202 using SMTP commands. At step 610, the MUA 402 sends a MAIL SMTP command specifying the sender's email address. At step 616, the SMTP session is terminated and the TCP connection are closed, and the process returns to step 602. Otherwise, if the sender is registered, the MTA 202 responds with a “Sender OK” message, and in response the MUA 402 sends an SMTP RCPT command specifying the recipient's email address. The MTA 202 receives this command at step 618, and queries the database at step 620 to determine whether the recipient is a local recipient, i.e., whether the domain of the recipient's email address is hosted by the storage system. If the recipient is not local, then at step 622, the database 107 is queried to determine whether the user is allowed to relay mail to non-local addresses, based on the sender's IP address. If not, then at step 624 a “relaying denied” message is returned and no further processing of the message is performed with respect to that recipient address. It will be appreciated that although the flow diagram of FIG. 6 is shown for a single recipient address, a message can be addressed to more than one recipient. If more than one recipient is specified, these steps are repeated for each subsequent recipient. If relaying is denied for all recipients of the message, then the connection is closed.

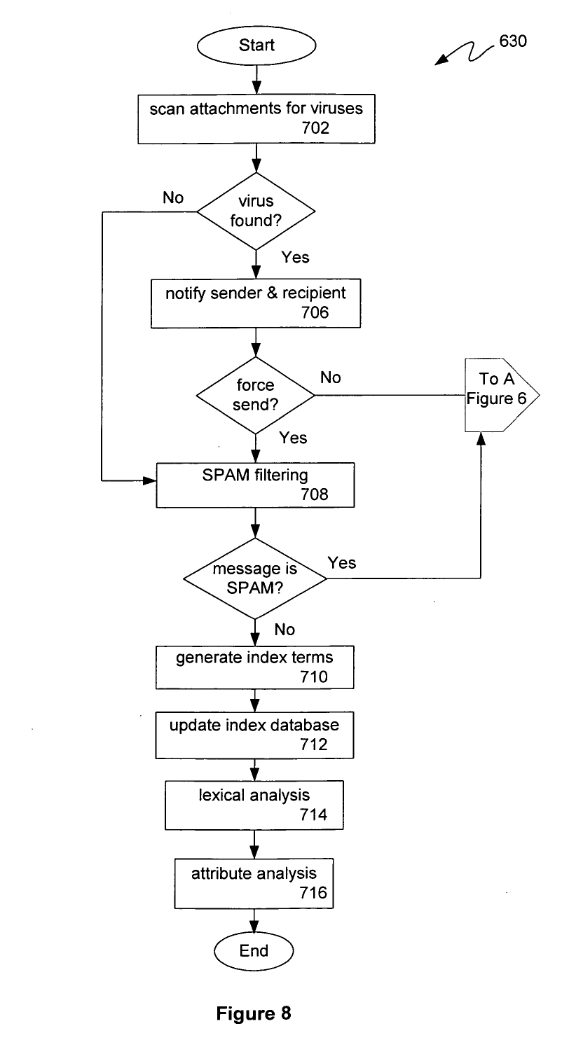

Alternatively, if relaying is allowed for at least one non-local recipient, or if at least one recipient is local, then the MTA 202 responds with a “recipient OK” message, and in response the MUA 402 sends, at step 626, an SMTP DATA command and the email message. The TCP connection is then closed at step 627. At step 628, attribute-value pairs (AVPs) are generated from the message header (e.g., sender=grant@primeinternet.com.au). The message is then analysed at step 630 using a message analysis process, as shown in FIG. 8. The analysis process begins by scanning any attachments to the email message for viruses. If a virus is found, then the sender and recipient are notified at step 706 and the mail message is quarantined. A quarantined message is not forwarded or delivered to the recipient, but is nevertheless stored in the database 107. However, in cases where a message is incorrectly identified as including a virus, the sender can force the mail message to be delivered by including a delivery flag within the body of the message. This delivery flag is the string “arcevault-opt-ignorevirus”. If the force flag was included, or if the message did not contain a virus, then the SPAM module 212 performs SPAM analysis of the message at step 708. If the message is SPAM, then no further processing of the message performed. Otherwise, index terms are generated for the message at step 710. The index terms are generated from the message by parsing the text of the message body to create index terms comprising single words and phrases up to six words in length. Common words such as “it”, “the”, “a”, and so on, referred to as stop words, are discarded unless they are part of a phrase with less common words. Index terms are also generated from message header data, including sender, receiver, subject, and date fields.

At step 712, an index table of the database 107 for the hosted domain for which the message is being stored is updated with the index terms. For each domain hosted by the storage system, i.e., a domain for which email messages are stored, an index table is used to store index terms for that domain. That is, when a user of a hosted domain sends an email message, index terms are generated for the outgoing message and stored in the index table for that sender's domain. Similarly, when a message is sent to a user of a hosted domain, the index terms for the incoming message are also generated and stored in the database for the hosted domain. In a case where both the sender and the recipient of the message correspond to two hosted domains, then the index terms are stored in the index tables for each corresponding domain. If the sender's domain and the recipient's domain are identical, then it is only necessary to store one copy of the index terms.

When an index table is updated for a domain, new index terms that are not already stored in the index table are added to the table, together with a database key referencing the corresponding email message. If an index term is already stored in the index table, then a key referencing the corresponding email address is added to the existing entry. Thus an index table contains a list of index terms, each term being associated with one or more database keys referencing respective messages from which the corresponding index term was generated. The index table facilitates rapid searching and retrieval of email messages, as described below.

Lexical analysis of the message is performed at step 714. The lexical analysis uses keyword and phrase matching on index terms generated in step 710 to detect inappropriate (e.g., sexually explicit) content. For example, a message and/or a stream of messages between participants of an ongoing communication (e.g., a sequence of mail/reply messages or mail messages without reply) and attempts to determine whether the contents of the message is unsuitable (e.g., whether the content indicates harassment, insider trading, and/or pornographic materials). For example, if several messages containing aggressive or suggestive language are all received from the same sender and addressed to the same recipient, the messages can be flagged for review. At step 716, message filtering is performed on the message based on message attributes, including message size, time sent, recipient, and message content. This completes the message analysis process.

Returning to FIG. 7, after analysis, an MD5 hash or checksum of the message is generated at step 632, and at step 634 a privacy statement is appended to the message body. At step 636, the message header, body, and metadata, including the checksum and a timestamp indicating the current date and time, are stored in the database 107. If the message is to be sent to a recipient, then it is processed as follows. If message recipient is a local user, the message is stored in a local mail spool directory of the storage system at step 638, and can subsequently be retrieved as described below. If the recipient is a non-local user, then the address of a corresponding remote mail server is determined in the standard manner using DNS at step 640. The DNS query retrieves the address of the mail server 120 of the second private network 112. The message is then delivered to the remote MTA 502 of the second private network 112 at step 642 using the SMTP protocol. If a message has a number of recipients, the message is delivered to each as described above.

Messages delivered locally on the storage system can be retrieved using the POP server 218 of the storage system. The POP server 218 records detailed usage data, including message identifiers, username and retrieving IP address, and bandwidth usage is recorded for billing purposes. The date, time, IP address, and message information are stored for security purposes, and are provided to administrators of the private networks 110, 112. The POP server 218 can be configured to deny connections based on IP address, clients with overdue payments (the only new message available to such a client is an account statement), and time of the day or date: for example, retrieval of messages can be denied after 5 pm weekdays and on weekends.

The storage system can also be used to store electronic documents that are not to be delivered to a recipient. This is achieved by creating an email message with a recipient address recognized by the storage system as indicating that the message is only to be stored on the storage system and not forwarded. Such an email address could be, for example, archive@email-archive.com, where email-archive.com is a domain name of the storage system. An electronic document attached to such a message is simply stored by the storage system, and only text in the body of such a message is stored as comment metadata with the document. After storing the documents, a reply is sent to a sender of the message, confirming that the document has been stored.

The storage system also stores email messages addressed to local users that originate from users of non-local networks, i.e., networks that are not hosted by the storage system. For example, an email message sent from a user of the (non-hosted) second private network 112 addressed to a user of the (hosted) first private network 110 is stored by the storage system using the storage process described above. In this case, the MUA 402 of the second private network 112 performs a DNS query for the MX record corresponding to the domain of the recipient's email address. Because the DNS server 101 of the storage system is the authoritative DNS server for the domain of the first private network 110, as described above, the MUA 402 sends the mail exchange (MX) DNS query to this DNS server 101, providing the domain name of the recipient's email address entered by the sender. In response, the DNS server 101 provides an IP address of the storage server farm 102 of the storage system as corresponding to the domain name. The email message is then transferred to and stored by the storage system, as described above.

The storage system thus maintains a copy of each email message it receives, together with metadata including a timestamp and checksum. Once stored, the information cannot be modified or deleted from the storage system. The metadata, particularly the checksum, is used to verify the contents of a disputed email message.

Users of the storage system can access stored information using the web browser application 404 on the user computer 118 to reference HTML and JavaScript-based scripts of the storage modules 214 that are retrieved by the web server 204 of a storage server 104 and sent to the browser 404 using SSL encryption. After providing username/password authentication to the system, the user can search for and display one or more stored messages that originated from or were addressed to an email address associated with the user's account. This provides the user with secure read-only access to the stored information. The storage system thus functions as a secure, off-site archive for email messages and documents. Such storage can be important for documentation, archiving, and legal investigations, as it prevents documents from being subsequently altered or destroyed.

High speed searching and retrieval of messages stored in the database 107 is facilitated by the index tables of the database 107. As described above, an index table stores index terms generated from messages stored by the storage system, together with one or more database keys referencing those messages. The index terms include words and phrases from the text of the email, in addition to header fields of the message. Accordingly, a user accessing the storage system can request messages matching various keyword and/or header criteria, and the storage system can locate a list of such messages rapidly, because the index table already includes a list of such messages. For example, a user can request a list of messages sent on a particular date. In response, a retrieval script of the storage modules 214 performs an SQL query that retrieves the list of database keys associated with an index term generated from the message header “Date:” field, combined with the sent date specified by the user. Additionally, the list of messages sent by the requesting user is also retrieved by requesting the index term generated from the message header “From:” field, combined with the user's email address, and the intersection of these two lists is used to identify the database keys of messages sent by the requesting user on the specified date. These keys are used to retrieve the corresponding messages from the database 107 so that they can be displayed to the user. More complex searches, such as specifying one or more header index terms including Subject, Date, From, To, and/or various index terms generated from the message body can be retrieved in a similar fashion. By indexing each message during the storage process, the time taken to search for and retrieve messages is greatly reduced, thus enhancing the user's interactive experience. It also reduces the load on the storage system during retrieval.

Many modifications will be apparent to those skilled in the art without departing from the scope of the present invention as herein described with reference to the accompanying drawings.

1. A storage process for electronic messages, the process including the steps of:
(a) receiving an electronic message over a messages network;
(b) generating metadata for the message that verifies content of the message; and
(c) archiving the message and the metadata to verify sending and content of the message.

2. A storage process according to claim 1 wherein, the process includes providing read-only access to the archived message.

3. A storage process according to claim 1 wherein, the metadata is generated by processing the message according to an encryption algorithm.

4. A storage process according to claim 1 wherein, the meta data is embedded within the archived message.

5. A storage process according to claim 1 wherein, the meta data is a digital fingerprint verifying sending and content of the message.

6. A storage process according to claim 1 wherein, the process includes determining whether a sender of the message is allowed access to the steps of the process on the basis of at least one of an email address of the sender and/or a network address associated with the sender.

7. A storage process according to claim 1 wherein, the message is addressed to at least one recipient, and the process includes the step of determining whether the recipient is a local recipient or a non-local recipient.

8. A storage process according to claim 1 wherein, the process includes determining whether a sender of the message is allowed access to relay the electronic message for a non-local recipient of the electronic message on the basis of a network address associated with the sender.

9. A storage process according to claim 1 wherein, the process includes storing the message for subsequent downloading to a remote computer system by a local recipient.

10. A storage process according to claim 9 wherein, the process includes denying access to the step of downloading on the basis of at least one of a network address of the remote computer system, the status of an account of the recipient, time of day, and day of week.

11. A storage process according to claim 1 wherein, the process includes determining whether the message can be forwarded to a non-local recipient on the basis of access privileges of the sender.

12. A storage process according to claim 1 wherein, the process includes determining whether the message includes a computer virus.

13. A storage process according to claim 12 wherein, the process includes notifying the sender and/or recipient if the message includes a computer virus.

14. A storage process according to claim 1 wherein, the process includes determining whether the message includes SPAM.

15. A storage process according to claim 14 wherein, the archiving step does not occur if the message includes SPAM.

16. A storage process according to claim 1 wherein, the process includes selecting the message on the basis of one or more attributes of the message.

17. A storage process according to claim 16 wherein, the attributes include one or more of size, time received, time sent, and recipient of the message.

18. A storage process according to claim 1 wherein, the process includes determining whether the message includes a word and/or phrase from a list of predetermined words and/or phrases.

19. A storage process according to claim 1 wherein, the metadata includes a checksum of the message.

20. A storage process according to claim 1 wherein, the metadata includes a timestamp of the message indicating when the message was sent.

21. A storage process according to claim 1 wherein, the process includes appending a privacy statement to the message.

22. A storage process according to claim 1 wherein, the step of receiving includes receiving the message using a simple mail transfer protocol (SMTP).

23. A storage process according to claim 1 wherein, the electronic message includes an email message.

24. A storage process according to claim 1 wherein, the email message includes an attached document.

25. A storage process according to claim 1 wherein, the process includes providing access to the steps of the process in exchange for a fee.

26. A storage process according to claim 1 wherein, the process includes generating one or more index terms for the message, and the step of archiving includes archiving the index terms.

27. A storage process according to claim 1 wherein, the index terms are generated from header data and/or body text of the message.

28. A storage process according to claim 1 wherein, each of the index terms includes at least one word.

29. A storage process according to claim 1 wherein, the message is addressed to a storage means that conducts the steps of the process.

30. A storage process according to claim 1 wherein, message is received by intercepting the message on route to the recipient to whom the message is addressed, and the steps of the process are then conducted on the intercepted message.

31. A storage process according to claim 30 wherein, the message is automatically forwarded to the recipient to whom the message is addressed after interception.

32. A storage process according to claim 30 wherein, the message is selectively forwarded to the recipient to whom the message is addressed on the basis of one or more criteria.

33. A storage process according to claim 32 wherein, the criteria include one or more of:
(a) whether the message is identified as SPAM;
(b) whether the message contains as computer virus;
(c) whether the message contains one or more predetermined words and/or phrases;
(d) whether a sender of the message is on a blacklist associated with a recipient of the message; and
(e) whether a recipient of the message is on a blacklist associated with the sender of the message.

34. A storage process according to claim 1 wherein, the archived message is stored at a storage means located on a secure computer remote from a sender and a recipient to whom the message is addressed.

35. A storage process for electronic messages sent between a sender and a recipient via a messages network, including the steps of:
(a) intercepting the electronic message on route to the recipient;
(b) creating an archive copy of the intercepted message;
(c) generating metadata to verify content of the archive copy; and
(d) archiving the archive copy and the meta data to verify sending and content of the electronic message.

36. A system for storing electronic messages, the system including:
(a) receiving means for receiving an electronic message over a messages network;
(b) encryption means for generating metadata for the message that verifies content of the message; and
(c) storage means for archiving the message and the metadata to verify sending and content of the message.

37. A system according to claim 36 wherein, the storage means provides only read-only access to the message.

38. A system according to claim 36 wherein, the encryption means includes an encryption algorithm and the message is processed according to the encryption algorithm to generate the metadata.

39. A system according to claim 36 including embedding means for embedding the metadata into the archived message.

40. A system according to claim 36 wherein, the metadata is a digital fingerprint verifying sending and content of the message.

41. A system according to claim 36 including virus detection means for detecting a computer viruses within the message.

42. A system according to claim 36 including unsolicited message detection means for detecting SPAM within the message.

43. A system according claim 36 wherein, the receiving means includes interception means for intercepting electronic messages on route to a recipient to whom the message is addressed.

44. A system according to claim 36 including means for detecting whether the recipient to whom the message is addressed is a local or non-local recipient.

45. A system according to claim 36 wherein, the metadata includes a checksum of the message.

46. A system according to claim 36 wherein, the metadata includes a timestamp of the message indicating when the message was sent.

47. A storage process for electronic messages sent and received by a user, the process including the steps of:
(a) intercepting electronic messages sent and received by the user;
(b) analysing each electronic message according to pre-determined criteria; and
(c) creating an archive copy of each electronic message which meets the pre-determined criteria; and for each archive copy, including the further steps of:
(i) generating a validation data for the archive copy to verify its content; and
(ii) archiving the archive copy and the validation data to verify sending and content of the electronic message.

48. A process according to claim 47 wherein, the user is a subscriber.

49. An electronic message management system, the system including:
(a) tracking means for tracking electronic messages sent to and from a subscriber; and
(b) storage means for storing electronic messages sent to and from a subscriber wherein the electronic messages are stored in a tamper proof manner to provide proof of content and sending.

50. Computer software including:
(a) tracking component to track electronic messages sent and received by the user;
(b) encryption component to generate metadata for one or the electronic messages to verify content of the message; and
(c) storage means for storing the message and metadata in a secure manner to verify and content of the message.
